(19) United States
(12) Patent Application Publication
(10) Pub. No.: US 2025/0288832 A1
(43) Pub. Date: Sep. 18, 2025

(54) RESPIRATORY PROTECTION MASK HAVING A LINEARLY MOVABLE DRINKING UNIT

(71) Applicant: Dräger Safety AG & Co. KGaA, Lübeck (DE)

(72) Inventors: Peer Groß, Lübeck (DE); Björn Felix Kröger, Lübeck (DE)

(21) Appl. No.: 19/076,064

(22) Filed: Mar. 11, 2025

(30) Foreign Application Priority Data
Mar. 13, 2024 (DE) 102024107081.1

(51) Int. Cl. A62B 18/08; A62B 18/10; A62B 23/02

(52) U.S. Cl. CPC A62B 18/086; A62B 18/10; A62B 23/02

(57) ABSTRACT

The disclosure relates to a respiratory protection mask having a support unit and a drinking unit. The support unit can be placed on the face of a user. The drinking unit can be moved linearly relative to the support unit in two opposite directions. A movement of the drinking unit-towards the support unit transfers the drinking unit to a drinking state. In this drinking state, a user of the respiratory protection mask can ingest a liquid from a connected liquid container without having to remove the respiratory protection mask. A movement of the drinking unit away from the support unit transfers the drinking unit to a spaced-apart state, in which a gap arises between the drinking unit and the face of the user.

### CROSS-REFERENCE TO RELATED APPLICATIONS

This application claims the priority of German Patent Application No. 102024107081.1, filed on Mar. 13, 2024, the entire contents of which being fully incorporated herein by reference.

### DESCRIPTION

The disclosure relates to a respiratory protection mask having a drinking unit.

The respiratory protection mask according to the disclosure comprises
like many respiratory protection masks known from the prior art-a support unit. As a rule, the support unit comprises
a main body that rests in a fluid-tight manner against the user's face and covers at least the mouth and nose,
a strap (banding) that holds the main body to the user's head, and
at least one filter unit.

As a rule, the or each filter unit can be detachably connected to the main body.

The respiratory protection mask allows the user to be in an environment in which the ambient air contains or may contain at least one gas and/or particles wherein the gas or the particles are harmful to humans. Thanks to the filter unit, ambient air is filtered before the user breathes it in (inhales it). The main body prevents ambient air from bypassing the filter unit and therefore prevents the user from breathing in unfiltered ambient air.

If the user spends a long time in a room with potentially harmful ambient air, it is often desirable for the user to be able to ingest liquids without leaving the environment and without having to remove the respiratory protection mask. A respiratory protection mask that makes this possible comprises a drinking unit.

DE 10 2011 016 805 B4 and U.S. Pat. No. 8,640,693 B2 describe a respiratory protection mask having a drinking unit. This drinking unit allows a user to drink liquids without having to remove the respiratory protection mask. A connecting element in the form of a drinking hose can be rotated relative to a fluid guide element that is firmly connected to the support unit.

The disclosure is based on the object of providing a respiratory protection mask having a support unit and a drinking unit, wherein the respiratory protection mask should be more flexible to use than respiratory protection masks known from the prior art.

The object is achieved by a respiratory protection mask having the features of claim 1. Additional embodiments of the respiratory protection mask are specified in the dependent claims.

The respiratory protection mask according to the disclosure comprises a support unit. The support unit is configured so that a flexible component of the support unit, in particular a face mask, can be placed on the face of a user of the respiratory protection mask. As a rule, the component of the support unit ideally separates at least the user's nose and mouth from the ambient air, in a fluid-tight manner except for defined openings. A respective filter unit or a source of breathing air can be connected to the openings. Filtered ambient air reaches the user's nose and mouth through the openings. As a rule, a strap (banding) on the respiratory protection mask holds this component to the user's face.

Furthermore, the respiratory protection mask according to the disclosure comprises a drinking unit. The drinking unit allows a user of the respiratory protection mask to drink a liquid while wearing a respiratory protection mask. A container for liquid, in particular a drinking bottle, can be connected to a connecting element of the drinking unit. The drinking unit also comprises a rigid fluid guide element and a mouthpiece. The mouthpiece is configured to be taken in the mouth by a user of the respiratory protection mask.

The fluid guide element and the connecting element are connected in series and together (jointly) are able to establish a fluid connection between the mouthpiece and a liquid container that is connected to the connecting element. Due to this fluid connection, a user of the respiratory protection mask can ingest liquid from the liquid container.

The disclosure makes it possible to connect a container with liquid to the connecting element. A user of the respiratory protection mask can drink a liquid from the connected liquid container, without having to remove the respiratory protection mask. This is important in particular if the user performs physical work where harmful gases and/or particles arise or may arise in the user's environment. Thanks to the drinking unit, it is also not necessary that the user leaves the potentially dangerous environment to ingest liquids.

According to the disclosure, the drinking unit can be moved relative to the support unit, namely linearly in two opposite directions. A sufficiently large linear movement of the drinking unit towards the support unit transfers the drinking unit into a drinking state. In the drinking state, the mouthpiece can be positioned in the user's mouth, so that the user can ingest liquid from the above-mentioned connected liquid container. A sufficiently large linear movement of the drinking unit away from the support unit transfers the drinking unit into a spaced-apart state. In the spaced-apart state, a gap arises between the mouthpiece and the mouth. In both states of the drinking unit, the flexible component of the support unit rests against the user's face.

According to the disclosure, the drinking unit can be transferred into the drinking state and into the spaced-apart state. As a result, it is not necessary that the user has the mouthpiece in his/her mouth permanently, even if he/she does not want to ingest any liquid. A user will often find it bothersome to have to keep a mouthpiece in his/her mouth permanently.

According to the disclosure, the drinking unit can be transferred into the drinking state by a linear movement relative to the support unit. This feature often has the effect that the drinking unit is particularly easy and intuitive to handle and use. In order to transfer the drinking unit into the drinking state, in many cases a user only needs to move the drinking unit towards his/her own face. In order to ingest a liquid while wearing a respiratory protection mask, it is not necessary to turn the drinking unit. It is also not necessary to use a tool for this purpose. The drinking unit can often be easily transferred into the drinking state even if the user is wearing gloves. As a rule, both left-handed and right-handed users can easily transfer the drinking unit into the drinking state.

According to the disclosure, a rigid fluid guide element connects the connecting element to the mouthpiece. A “fluid guide element” is understood to mean a component that is capable of guiding a fluid along a trajectory, wherein this trajectory is predetermined by the design and arrangement of the component. A rigid tube and a flexible hose are two examples of a fluid guide element. Ideally, the component prevents the fluid from leaving the trajectory.

Since the rigid fluid guide element connects the connecting element to the mouthpiece, it is not necessary to position a hose or other flexible fluid guide element in the respiratory protection mask. Such a flexible component can get caught or hooked or kinked and/or might not reach the user's mouth.

In one embodiment, a sheathing surrounds the fluid guide element, both if the drinking unit is in the drinking state and if the drinking unit is in the spaced-apart state. The sheathing protects the fluid guide element to a certain extent against mechanical and chemical damage from the outside. As a result, the fluid guide element can in many cases be configured to be lighter compared to an embodiment without a sheathing. The sheathing is mechanically connected to the support unit on one side and to the connecting element on the other side. The length, i.e., the dimension of the sheathing along a longitudinal axis of the fluid guide element, is variable. Possible embodiments of such a sheathing are a corrugated hose, a bellows, and a telescopic hose. Thanks to this feature, the sheathing surrounds the fluid guide element in both states of the drinking unit and does not significantly hinder the linear movement of the drinking unit relative to the support unit.

In one embodiment, the sheathing comprises a resilient (springy, elastic) component or is implemented as a resilient component. The resilient component has a resting state. If the resilient component and thus the sheathing are in the resting state, the drinking unit is in the spaced-apart state. A deflection of the sheathing from the resting state triggers the sheathing to cause a resetting spring force. This resetting spring force endeavors to move the sheathing back to the resting state. In order to bring the drinking unit into the drinking state, the drinking unit is moved linearly and against the resetting spring force towards the support unit.

The embodiment that the sheathing comprises a resilient element with a resting state or is implemented to be resilient has in particular the following advantage: As a rule, in order to transfer the drinking unit into the spaced-apart state, a user hardly needs to exert any force or spend any time. As a rule, it is sufficient to let go of (release) the drinking unit. The resetting spring force of the sheathing automatically transfers the drinking unit to the spaced-apart state.

According to the disclosure, the drinking unit is linearly movable relative to the support unit and thus relative to the face of a user. In one embodiment, a guide element is mechanically connected to the support unit. The guide element guides the drinking unit during a linear movement from one state to the other state. The guide element guides the rigid fluid guide element and in particular comprises a tube, preferably a rigid tube, wherein the tube surrounds a segment of the fluid guide element or even the entire fluid guide element. This embodiment reduces the risk of the following undesirable event arising if a liquid container is connected to the connecting element: A fluid connection between the mouthpiece and the liquid container is restricted or even interrupted because the fluid guide element kinks or hooks or slips.

The respiratory protection mask according to the disclosure comprises a rigid fluid guide element and a connecting element. In one embodiment, the rigid fluid guide element extends along a longitudinal axis, called fluid guide element longitudinal axis. The connecting element extends along a longitudinal axis, called connecting element longitudinal axis. Preferably, an angle greater than zero arises between these two longitudinal axes, wherein this angle is a right angle or an acute angle. This embodiment makes it easier to position a liquid container in front of a user's chest and below the fluid guide element longitudinal axis. As a result, the liquid container is in many applications less disturbing than in an embodiment with which the fluid guide element and the connecting element are arranged collinear to one another.

According to the disclosure, a liquid container can be connected to the connecting element, and may be connected detachably. In one embodiment, the connecting element can be rotated relative to the fluid guide element about the longitudinal axis of the fluid guide element. As a result, a connected liquid container can also be rotated about this longitudinal axis. This embodiment further increases the flexibility during the application and use of the respiratory protection mask according to the disclosure. In particular, this embodiment makes it easier for a user to hold a connected liquid container either in the left hand, in the right hand or with both hands, and to ensure that the connecting element is positioned and oriented accordingly.

In one embodiment, a non-return valve is arranged in the connecting element. This non-return valve has a resting state. In the resting state, the non-return valve seals the connecting element in a fluid-tight manner against the environment. When the non-return valve is closed, neither harmful gases nor particles can reach the face of a user of the respiratory protection mask through the connecting element. The non-return valve can be opened against a resetting spring force of a spring element. When the non-return valve is open, the user can ingest liquid from a connected liquid container.

In one application, the non-return valve opens against the resetting spring force if a negative pressure (underpressure) occurs in the end of the connecting element that points towards the fluid guide element. As a rule, this negative pressure is generated by a user who draws (sucks) in liquid. In another application, the non-return valve opens against the resetting spring force of the non-return valve if an overpressure occurs in the end of the connecting element pointing towards a connected liquid container. This overpressure can be generated, for example, by compressing the liquid container or as an overpressure in the liquid container occurs. The following embodiment is also possible: If the liquid container is connected to the connecting element, a projection on the liquid container opens the non-return valve against the resetting spring force.

It is also possible that a rigid element is able to open the non-return valve. This rigid element is preferably in a fluid connection with a liquid container that is connected to the connecting element, optionally also in a mechanical connection. The rigid element opens the non-return valve against the resetting force during the step that the liquid container and thus the rigid element are connected to the connecting element. In many cases, it is easier to open the non-return valve with the aid of this rigid element than by generating a negative pressure or overpressure. A further advantage of using such a rigid element: In many cases, the resetting spring force of the non-return valve can be greater, so that the non-return valve is closed with greater reliability.

The support unit may comprise at least one holder. This holder comprises an opening. A respective filter unit can be detachably connected to the or each holder, for example with the aid of a screw cap, bayonet catch or snap-in catch. The opening establishes a fluid connection between an environment of the respiratory protection mask and an interior space, wherein this interior space arises between the support unit and a user's face. Thanks to the detachable connection, a filter unit can be replaced. Preferably, a lateral gap arises between the or each holder and the drinking unit, so that a filter unit can be replaced even when the respiratory protection mask is used (on a user's face) and the drinking unit does not hinder this replacement. Conversely, the filter unit does not interfere with the use of the drinking unit, or only to a minor extent.

The disclosure further relates to an arrangement that comprises
a respiratory protection mask according to the disclosure in accordance with the embodiment having the non-return valve,
a container for liquid and
a fluid guide unit, preferably a rigid fluid guide unit.

The fluid guide unit is firmly or detachably connected to the liquid container, so that a fluid connection is established between the liquid container and the fluid guide unit. An opening is recessed into the fluid guide unit. The fluid guide unit can be pushed into the connecting element. If the fluid guide unit is pushed into the connecting element, the non-return valve is or will be opened. The connecting element surrounds a segment of the fluid guide unit and thus the opening. A fluid connection is then established between the liquid container and the mouthpiece of the respiratory protection mask. This fluid connection passes through the opening inside the connecting element.

In the following, the disclosure is described on the basis of an exemplary embodiment. In the drawings,

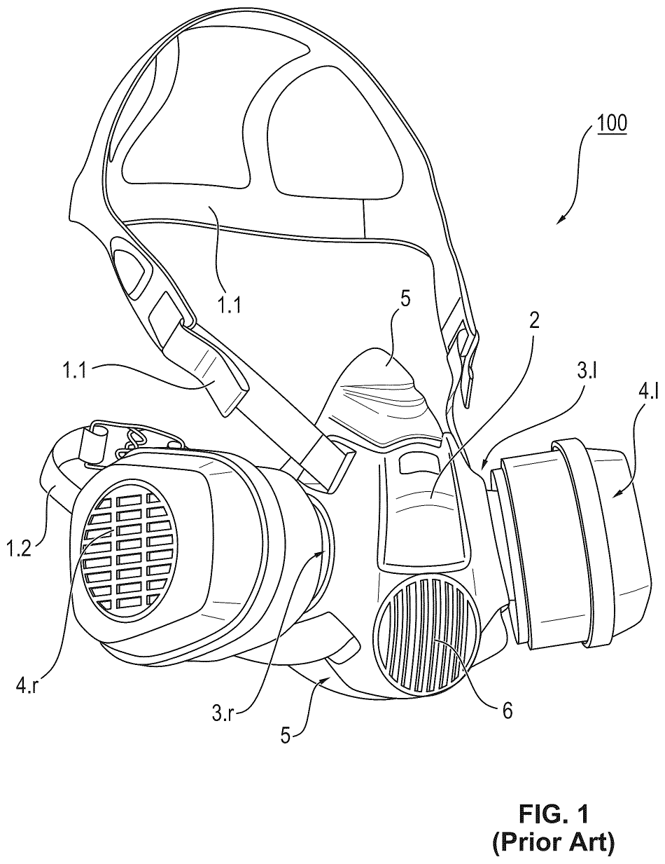

FIG. 1 shows a respiratory protection mask without a drinking unit;

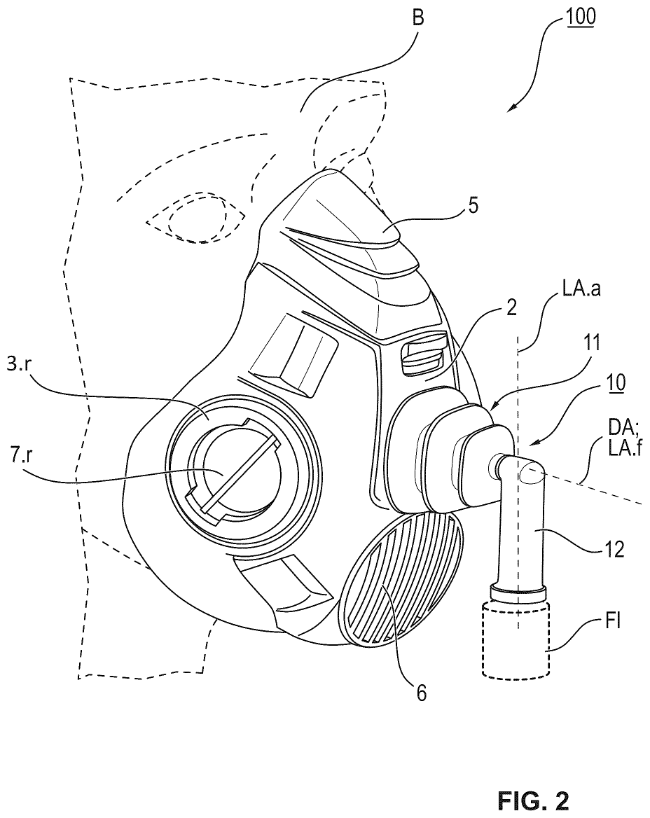

FIG. 2 is a perspective view of a respiratory protection mask according to the disclosure having a drinking unit;

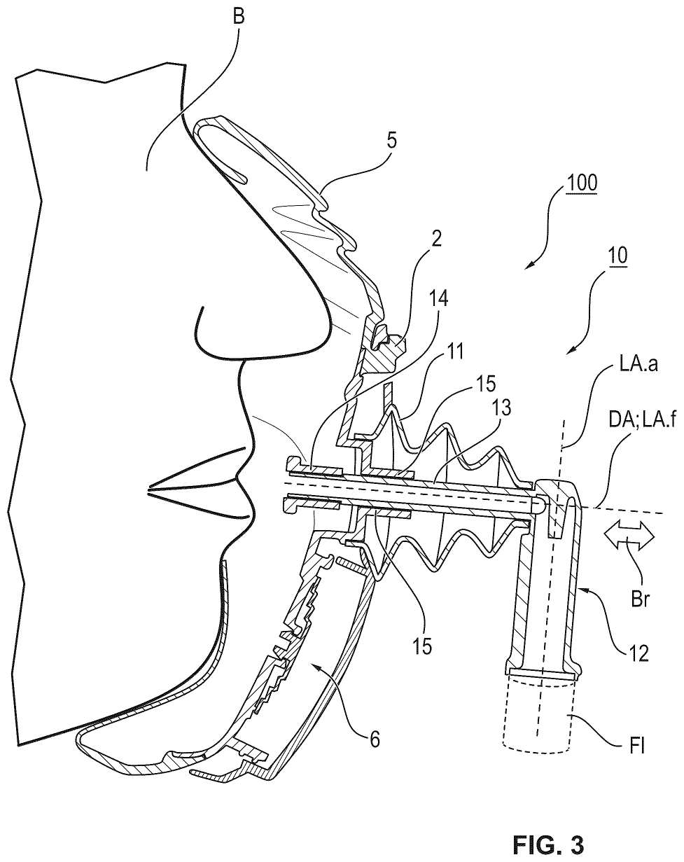

FIG. 3 is a cross-sectional view of the respiratory protection mask shown in FIG. 2;

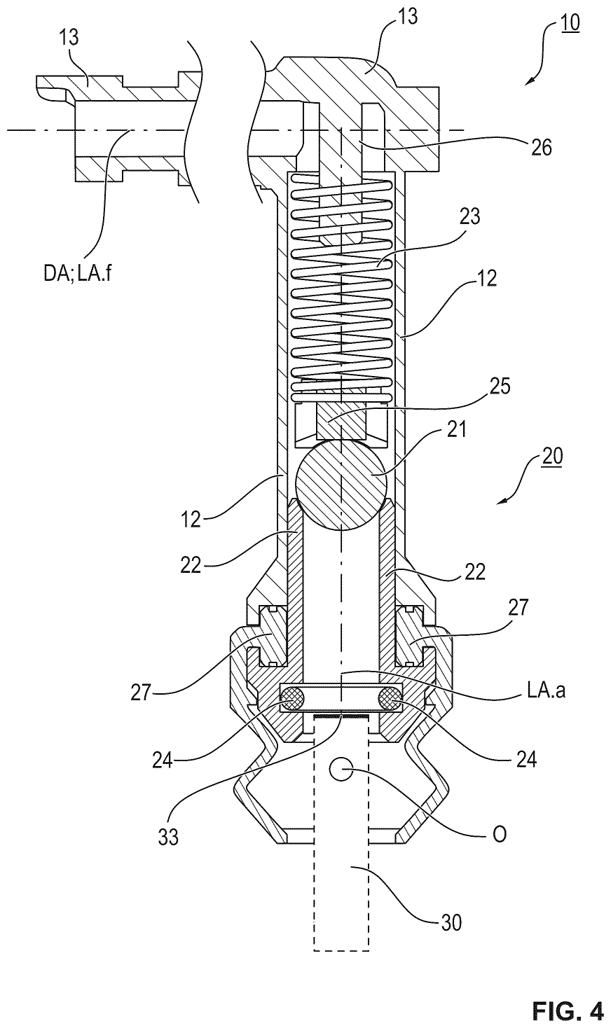

FIG. 4 is a cross-sectional view of a drinking unit having a non-return valve;

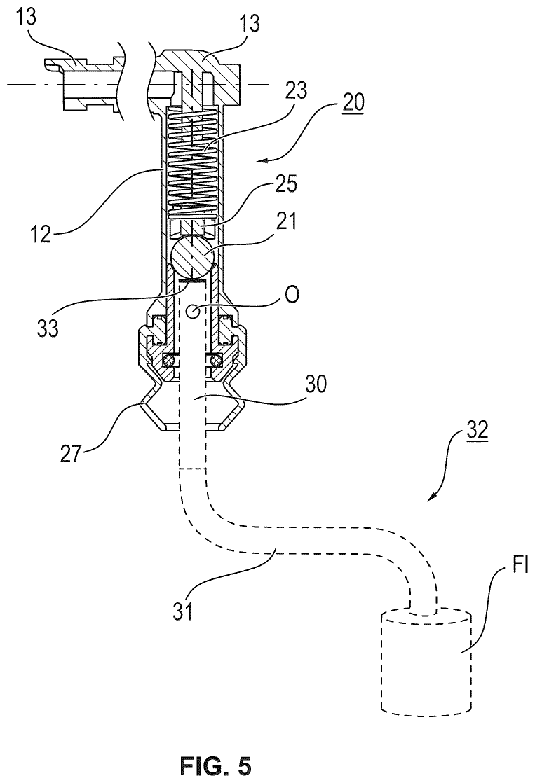

FIG. 5 shows how a drinking bottle can be connected to the drinking unit;

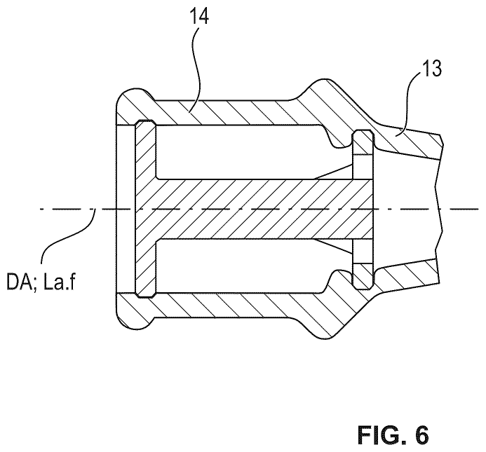

FIG. 6 is a cross-sectional view of a bite mouthpiece for the drinking unit.

FIG. 1 shows a respiratory protection mask 100 as known from the prior art. The respiratory protection mask 100 comprises a main body 2, a seal 5, and a two-part strap 1.l, 1.2. The seal 5 is connected to the main body 2 in a fluid-tight manner. A left-hand holder 3.l and a right-hand holder 3.r are fastened to the main body 2, wherein the two holders 3.l, 3.r have the form of a screw cap or bayonet catch or snap catch. A respective filter unit 4.l, 4.r can be detachably inserted into the two holders 3.l, 3.r.

If a user B wears the respiratory protection mask 100, the seal 5 ideally rest in a fluid-tight manner in front of the mouth and nose of the user B, and the straps 1.l, 1.r rest against the back of the head and hold the seal 5 in front of the mouth and nose. An outlet valve 6, which is located in front of the user's mouth B, is arranged in the main body 2. Exhaled air flows through the outlet valve 6.

This disclosure makes it possible for the user B to ingest liquids without having to remove the respiratory protection mask 100. For this purpose, the respiratory protection mask 100 according to the present disclosure comprises a drinking unit 10. A bottle or other container FI can be connected to this drinking unit 10, wherein the container FI contains a liquid and wherein the user B can draw (suck) in the liquid through the drinking unit or otherwise convey it to the mouth, e.g. by pressing together the bottle Fl.

FIG. 2 shows a perspective view of the respiratory protection mask 100 according to the disclosure, shown at an angle from the right, positioned in front of the nose and mouth of the user B. FIG. 3 shows a cross-sectional view of the respiratory protection mask of FIG. 2. In FIG. 2, a cap 7.r is placed on the right-hand holder 3.r instead of the filter unit 4.r.

A drinking unit 10 is fastened to the main body 2. The drinking unit 10 of the exemplary embodiment comprises
a mouthpiece 14,
a fluid guide element 13 in the form of a rigid tube,
a tubular rigid guide element 15,
a sheathing in the form of a bellows 11, and
a connecting element 12, which is connected to the bellows 11 in a fluid-tight manner.

The mouthpiece 14 is fastened in a fluid-tight manner to an end of the tube 13, this end facing the user's mouth. The tube 13 establishes a fluid connection between the mouthpiece 14 and the connecting element 12. The guide element 15 is connected to the main body 2 in a rotationally fixed (torsion-proof) and fluid-tight manner and surrounds a segment of the tube 13.

The sheathing in the form of a bellows 11 is connected to the main body 2 in a fluid-tight manner and to the connecting element 12 in a fluid-tight manner and completely and concentrically surrounds the tube 13 in the exemplary embodiment.

The sheathing 11, the tube 13, and the guide element 15 extend along a common longitudinal axis LA.f. The extension of the rigid tube 13 along the longitudinal axis LA.f is invariable, while the extension of the sheathing 11 along the longitudinal axis LA.f is variable. Since the length of the sheathing 11 is variable, the connecting element 12 can be moved relative to the main body 2 linearly in two opposite directions parallel to the longitudinal axis LA.f. These two opposing directions are indicated by the double arrow Br in FIG. 3. The guide element 15 guides the tube 13 during a movement parallel to the longitudinal axis LA.f and prevents the tube 13 from tilting or twisting. In the embodiment shown, the guide element 15 limits a movement of the tube 13 away from the mouth of the user B, namely because the mouthpiece 14 abuts from the inside against the guide element 15.

In the exemplary embodiment, the connecting element 12 is connected in a rotationally fixed (torsion-proof) manner to the tube 13, and the mouthpiece 14 is also connected in a rotationally fixed manner to the tube 13. In one embodiment, the connecting element 12, the tube 13, and the mouthpiece 14 can be rotated together about an axis of rotation DA relative to the main body 2 and relative to the guide element 15. In one embodiment, the bellows 11 is sufficiently resilient to be reversibly twisted within itself. In another embodiment, the tube 13 can rotate relative to the bellows 11, and nevertheless the bellows 11 encloses the tube 13 in a fluid-tight manner in any rotational position. In the exemplary embodiment, the axis of rotation DA coincides with the longitudinal axis LA.f. The axis of rotation DA and thus the longitudinal axis LA.f are arranged to be horizontal if the user B is looking horizontally forwards.

Thanks to the bellows 11, the gap between the connecting element 12 and the container FI, on the one hand, and the user's mouth B, on the other hand, can be changed. FIG. 2 and FIG. 3 show the bellows 11 in a resting state. If the bellows 11 is in the resting state, a gap arises between the mouth of the user B and the mouthpiece 14. The drinking unit 10 is then in a spaced-apart state.

To enable the user B to drink from a container FI connected to the connecting element 12, the drinking unit 10 is pushed onto the mouth of the user B in a direction parallel to the longitudinal axis LA.f until the mouthpiece 14 reaches the mouth and the user B can take up (ingest) liquid from the container FI and drink. As a rule, the user B himself/herself can grasp the connecting element 12 and move it towards his/her face, thereby moving the drinking unit 10 linearly. This movement can, however, also performed by another human. The drinking unit 10 is in a drinking state if the user B can surround the mouthpiece 14 with his/her mouth.

If the drinking unit 10 is pushed towards the face of user B, the bellows 11 is compressed. The compressed bellows 11 exerts a resetting spring force in the manner of a spring element. The resetting spring force endeavors to bring the bellows 11 back into the resting state and as a result to move the drinking unit 10 away from the face of the user B and into the spaced-apart state. Therefore, no action by user B is necessary to hold the mouthpiece 14 at a distance from the mouth. Rather, the bellows 11 automatically moves the drinking unit 10 into the spaced-apart state and holds the drinking unit 10 there. The bellows 11 surrounds the tube 13 both in the drinking state and in the spaced-apart state.

If no bottle FI is connected to the connecting element 12, no air from the environment is to reach the user B through the connecting element 12 and the tube 13. It is conceivable to close the connecting element 12 with a cap. FIG. 4 schematically illustrates a different or additional embodiment that has the following effect: If the respiratory protection mask 100 is in the spaced-apart state, air from the environment is prevented from passing through the connecting element 12 to the user B, even if no liquid container FI is connected to the connecting element 12.

In one embodiment, a non-return valve 20 is arranged in the connecting element 12. FIG. 4 shows an embodiment of this non-return valve 20.

In the embodiment shown, an adapter 27 is detachably fastened to the free end of the connecting element 12, for example with a screw cap. This adapter 27 surrounds in a fluid-tight manner a neck of a further end piece 30 described below. In addition, the free end of the connecting element 12 is surrounded by a sealing ring 24.

The non-return valve 20 comprises
a spherical valve body 21,
a valve body seat 22,
a compression spring 23, and
a movable stop element 25.

The valve body seat 22 is attached to the inside of the connecting element 12. The compression spring 23 is supported on the tube 13 and endeavors to press the valve body 21 against the valve body seat 22, as a result closing the non-return valve 20. The movable stop element 25 is firmly connected to the valve body 21. The valve body 21 can be moved away from the valve body seat 22 against the force of the compression spring 23 until the movable stop element 25 comes into contact with a firmly mounted stop element 26. The stop element 26 is firmly connected to the tube 13.

In one embodiment, the user B draws in liquid from the bottle FI or squeezes the bottle FI. As a result, the non-return valve 20 is opened.

FIG. 5 shows another possible embodiment of how a liquid container FI can be connected to the connecting element 12. This other embodiment allows the compression spring 23 to exert a stronger spring force and as a result close the non-return valve with greater reliability. It is not necessary for the user B to open the non-return valve 20 by drawing in liquid. A fluid guide unit 32 is connected to the liquid container FI in a fluid-tight manner. The fluid guide unit 32 comprises a rigid end piece 30 with an opening O and a flexible hose 31. The hose 31 is firmly or detachably connected to the container FI and connected firmly and in a fluid-tight manner to the end piece 30. The rigid end piece 30 can be inserted into the interior of the connecting element 12 and has a rigid plate 33 that faces the valve body 21. The opening O has a gap from the rigid plate 33.

If the end piece 30 is inserted into the connection piece 12, the end piece 30 moves the valve body 21 against the resetting force of the spring 23. In the situation shown in FIG. 5, this plate 33 rests against the valve body 21, but the non-return valve 20 is still closed. The non-return valve 20 is opened if the end piece 30 is pushed further into the connecting element 12. The opening O is then surrounded by the connecting element 12. The user B can then take up liquid from the liquid container FI through the fluid guide unit 32 and the opening O and the drinking unit 10.

FIG. 6 schematically shows a cross section through a bite mouthpiece 14.

List of reference signs

| | |
|---|---|
| 1.1, 1.2 | Strap, rests against the back of the user's head B |
| 2 | Main body, carries the holders 3.l, 3.r and the exhalation |
| | valve 6, is connected to the seal 5 in a fluid-tight manner |
| 3.l, 3.r | Holders for the filter units 4.l, 4.r |
| 4.l, 4.r | Filter units, detachably connected to holders 3.l, 3.r |
| 5 | Seal, rests in a fluid-tight manner against the face of the |
| | user B, connected in a fluid-tight manner to the main body 2 |
| 6 | Exhalation valve in the main body 2, located between the |
| | holders 3.l and 3.r |
| 7.l, 7.r | Caps for the holders 3.l, 3.r |
| 10 | Drinking unit, connected in a fluid-tight manner to the |
| | main body 2, comprises the mouthpiece 14, the tube 13, |
| | the bellows 11, the guide element 15, and the |
| | connecting element 12 |
| 11 | Bellows, connected to the main body 2 and the connecting |
| | element 12 |
| 12 | Connecting element, connected to the bellows 11, can be |
| | connected to a container Fl for liquid, rotatable relative |
| | to the bellows 11 about the axis of rotation DA, connected |
| | to the tube 13 in a rotationally fixed manner |
| 13 | Fluid guide element in the form of a rigid tube connects the |
| | mouthpiece 14 with the connecting element 12, |
| 14 | Mouthpiece, connected in a rotationally fixed manner to one |
| | end of the fluid guide element 13 |
| 15 | Guide element, guides the tube 13, fastened to the outside of |
| | the main body 2 and connected in a rotationally fixed manner |
| | to the main body 2 |
| 20 | Non-return valve in the connecting element 12, comprises the |
| | valve body 21, the valve body seat 22, the compression |
| | spring 23 and the connecting element 24 |
| 21 | Spherical valve body of the non-return valve 20, is pressed |
| | against the valve body seat 22 by the compression spring 23 |
| 22 | Valve body seat of the non-return valve 20, attached on the |
| | inside of the connecting element 12 |
| 23 | Compression spring of the non-return valve 20, is supported |
| | on the tube 13 |
| 24 | Sealing ring at the free end of the connecting element 12 |
| 25 | Movable stop element, firmly connected to the valve body 21 |
| 26 | Firmly mounted stop element, firmly connected to the tube 13 |
| 27 | Adapter at the free end of the connecting element 12, |
| | encloses the neck of a container Fl in a fluid-tight manner |
| 30 | Rigid end piece, comprises the plate 33 and the opening O, is |
| | surrounded in a fluid-tight manner by the adapter 27 in one |
| | embodiment, can be pushed into the connecting element 12 and |
| | opens the non-return valve 20 when pushed in, is connected to |
| | a container Fl by means of the fluid guide unit 32 |
| 31 | Flexible hose of the fluid guide unit 32 |
| 32 | Fluid guide unit, connects the container Fl to the connecting |
| | element 12, comprises the end piece 30 and the hose 31 |
| 33 | Rigid plate at the end of the end piece 30 that faces the valve |
| | body 21 |
| 100 | Respiratory protection mask, comprising the main body 2, the |
| | strap 1, the seal 5, the exhalation valve 6, the holders |
| | 3.l, 3.r, the filter units 4.l, 4.r, and the drinking unit 10 |
| B | User wearing the respiratory protection mask 100 in front of |
| | his/her mouth and nose |
| Br | Opposite directions in which the drinking unit 10 can be |
| | moved relative to the main body 2 |
| DA | Axis of rotation about which the connecting element 12 can be |
| | rotated relative to the bellows 11, coincides with the |
| | longitudinal axis LA.f |
| Fl | Bottle with a drinkable liquid, can be connected to the |
| | connecting element 12 |
| LA.a | Longitudinal axis of the connecting element 12 |
| LA.f | Longitudinal axis of the rigid tube 13 |
| O | Opening in the rigid end piece 30 |

1. A respiratory protection mask comprising: a support unit;
wherein a component of the support unit is configured to rest on the face of a user;
a drinking unit,
wherein the drinking unit comprises
a rigid fluid guide element,
a mouthpiece, and
a connecting element;
wherein the fluid guide element is mechanically connected to the connecting element and mechanically connected to the mouthpiece;
wherein the connecting element is configured such that a liquid container is detachably connected or connectable to the connecting element;
wherein the fluid guide element and the connecting element are configured to jointly establish a fluid connection between the mouthpiece and the liquid container;
wherein the drinking unit
is linearly movable relative to the support unit in two opposite directions and
can be transferred into a drinking state by a linear movement towards the support unit and into a spaced-apart state by a linear movement away from the support unit; and
wherein in the drinking state the mouthpiece can be positioned in the user's mouth and in the spaced-apart state a gap arises between the mouthpiece and the user's mouth.

2. The respiratory protection mask according to claim 1,
wherein
the drinking unit further comprises a sheathing that is variable in length;
in particular a corrugated hose or a bellows,
wherein the sheathing is mechanically connected to the support unit and mechanically connected to the connecting element; and
wherein the sheathing surrounds the fluid guide element both in the drinking state and in the spaced-apart state.

3. The respiratory protection mask according to claim 2,
wherein
the sheathing is a resilient component and has a resting state;
wherein a deflection of the sheathing from the resting state triggers a resetting spring force;
wherein the resetting spring force is configured to move the sheathing back into the resting state; and
wherein, if the sheathing is in the resting state, the drinking unit is in the spaced-apart state.

4. The respiratory protection mask according to claim 1, wherein
the respiratory protection mask comprises a guide element; and
wherein the guide element
is mechanically connected to the support unit and
is configured to guide the drinking unit during a linear movement relative to the support unit.

5. The respiratory protection mask according to claim 1, wherein
the fluid guide element extends along a fluid guide element longitudinal axis and
the connecting element extends along a connecting element longitudinal axis;
wherein a right or acute angle arises between these fluid guide element longitudinal axis and the connecting element longitudinal axis.

6. The respiratory protection mask according to claim 5, wherein
the connecting element is rotatable relative to the fluid guide element about the fluid guide element longitudinal axis.

7. The respiratory protection mask according to claim 1, wherein,
the support unit comprises at least one holder; and
wherein a respective filter unit can detachably be connected to each of the at least one holder.

8. The respiratory protection mask according to claim 1, wherein
a non-return valve is arranged in the connecting element;
wherein the non-return valve
is closed when being in a resting state and
in the resting state, seals the connecting element in a fluid-tight manner against the environment; and
wherein the non-return valve is configured to
causes a resetting force when being deflected out of the resting state, can be opened against the resetting force, and,
when in the open position, is configured to releases a fluid connection between the connecting element and the environment.

9. An arrangement, comprising:
the respiratory protection mask according to claim 8;
a liquid container; and
a fluid guide unit,
wherein the fluid guide unit
is at one end firmly or detachably connected to the liquid container and
comprises an opening;
wherein the fluid guide unit is configured
to open the non-return valve when the fluid guide unit is pushed into the connecting element;
wherein, if the fluid guide unit is pushed into the connecting element,
the connecting element surrounds the opening in the fluid guide unit and
a fluid connection is established between the liquid container and the mouthpiece; and
wherein this the fluid connection passes through the opening.
